(19) United States
(12) Patent Application Publication
(10) Pub. No.: US 2023/0182561 A1
(43) Pub. Date: Jun. 15, 2023

(54) MOTOR VEHICLE

(71) Applicant: MAHLE International GmbH, Stuttgart (DE)

(72) Inventors: Richard Bruemmer, Stuttgart (DE); Thomas Strauss, Notzingen (DE)

(21) Appl. No.: 18/078,880

(22) Filed: Dec. 9, 2022

(30) Foreign Application Priority Data
Dec. 10, 2021 (DE) 10 2021 214 104.8

(51) Int. Cl. B60K 11/02

(52) U.S. Cl. CPC B60K 11/02; B60K 2001/006

(57) ABSTRACT

A motor vehicle may include a drive mechanism, a discharge system through which a gas mass flow containing liquid droplets may flow, a pressure-reducing mechanism incorporated in the discharge system, a cooling circuit through which a coolant may circulate to cool a drive component of the drive mechanism, a coolant radiator through with the coolant may flow, an air path extending through the coolant radiator, an evaporative cooling mechanism, a reservoir free of applied additional pressure, a liquid path, and a supply path. The pressure-reducing mechanism may be configured such that the gas mass flow downstream of the pressure-reducing mechanism is free of applied additional pressure. The evaporative cooling mechanism may be configured to introduce liquid into the air path. The liquid path may extend from the pressure-reducing mechanism to an inlet of the reservoir. The supply path may extend from the storage volume to the evaporative cooling mechanism.

### CROSS-REFERENCE TO RELATED APPLICATIONS

This application claims priority to German Patent Application No. DE 10 2021 214 104.8, filed on Dec. 10, 2021, the contents of which is hereby incorporated by reference in its entirety.

### TECHNICAL FIELD

The present invention relates to a motor vehicle having a drive device and a cooling circuit for cooling a drive component of the drive device.

### BACKGROUND

The drive components being employed in a motor vehicle require a progressively increased cooling. In at least partially electrically driven motor vehicles the requirement of efficient cooling increases. In a battery-electric motor vehicle, increased cooling capacities for cooling the battery as drive component, are required for example when charging the battery. When the motor vehicle comprises a fuel cell as drive component, increased cooling capacities are likewise required.

In order to provide these increased cooling capacities, motor vehicles usually comprise a cooling circuit through which, during the operation, a coolant circulates and cools the drive components. Generally, the coolant in turn is cooled by a gas flow, in particular by air. For this purpose, the coolant flows through a coolant radiator which, fluidically separated from the coolant, is additionally flowed through by air.

During the operation of a motor vehicle liquid is generally created, in particular water. This liquid is usually contained in a gas mass flow in the form of liquid droplets. The gas mass flow containing the liquid droplets is usually discharged from the motor vehicle by means of a discharge system.

### SUMMARY

The present invention deals with the object of stating for a motor vehicle of the type mentioned at the outset an improved or at least other embodiment which is characterised in particular by an increased efficiency.

According to the invention, this object is solved through the subject matter of the independent claim(s). Advantageous embodiments are the subject matter of the dependent claim(s).

The present invention is based on the general idea of cooling the coolant circulating through the cooling circuit during the operation by means of a coolant radiator in a motor vehicle which comprises a cooling circuit for cooling a drive component of a drive device, which radiator, further, is flowed through by air, wherein for increasing the cooling capacity of the coolant radiator an evaporative cooling is also employed, in that evaporating liquid is fed to the air flow at and/or upstream of the coolant radiator. The liquid required for this purpose is at least partially extracted from a gas mass flow already existing in the motor vehicle, which gas mass flow contains liquid droplets, and the said liquid is collected in a reservoir. The gas mass flow and the reservoir are free of applied additional pressure. In particular, the gas mass flow is free of overpressure and the reservoir pressureless. The use of the evaporative cooling results in an increased efficiency in the cooling of the drive components and thus an increased efficiency of the motor vehicle. By extracting the liquid from the existing gas mass flow, the efficiency, beside a more autonomous operation of the motor vehicle, is further increased. The configuration of the reservoir free of applied additional pressure further results in that the liquid can be collected and/or extracted from the gas mass flow in a simplified manner and the liquid can be employed for the evaporative cooling in a simplified manner. This also results in an increased efficiency of the motor vehicle.

According to the inventive idea, the motor vehicle comprises a drive device for driving the motor vehicle. For driving the motor vehicle, the drive device comprises a drive component. Further, the motor vehicle comprises a discharge system through which, during the operation, the gas mass flow containing the liquid droplets flows, in particular is discharged. In the discharge system, a device is incorporated which is configured in such a manner that the gas mass flow downstream of the device is free of applied additional pressure, in particular is not subject to an overpressure. In the following, this device is also referred to as pressure reducing device. Further, the motor vehicle comprises the cooling circuit through which the coolant circulates during the operation. The drive component is incorporated in the cooling circuit and is cooled by the coolant during the operation. The coolant flows through the coolant radiator. A flow path of gas, in the following also generally referred to as air, additionally flows, fluidically separated from the coolant, through the coolant radiator, in order to cool the coolant. This flow path is also referred to as air path in the following. Further, the motor vehicle comprises a device which, during the operation, introduces liquid into the air path so that the liquid evaporates on the coolant radiator. The device is also referred to as evaporative cooling device in the following. The evaporation of the liquid results in an increased cooling of the coolant in the coolant radiator. Further, the motor vehicle comprises the in particular pressureless reservoir free of applied additional pressure. A flow path leads from the pressure reducing device or downstream of the pressure reducing device to an inlet of the reservoir. This takes place in such a manner that the flow to the reservoir is free of applied additional pressure, in particular free of overpressure. This flow path is also referred to as liquid path in the following. Further, the liquid path leads to the inlet of the reservoir in such a manner that liquid contained in the gas mass flow, flows into a storage volume of the reservoir. A flow path for supplying the evaporative cooling device with the liquid leads from the storage volume to the evaporative cooling device. This flow path is also referred to as supply path in the following. Thus, the storage volume is free of applied additional pressure, in particular free of overpressure.

In order to feed the liquid stored in the storage volume to the evaporative cooling device, a feed device, for example a pump, can be arranged in the supply path, which, during the operation, feeds liquid from the storage volume to the evaporative cooling device. When the storage volume with respect to the vertical direction is above the evaporative cooling device, gravity can alternatively or additionally serve for feeding the liquid.

Advantageously, the liquid is water.

Here, “free of applied additional pressure” is to mean that no pressure in addition to the prevailing pressure is specifically generated. In particular, no external pressure is thus generated. Exempted from this are in particular pressure generated by own weight and/or pressure caused by flows.

For the sake of simplicity, the expressions “pressureless”, “no overpressure”, “free of overpressure” and “overpressure-free” are also used in the following for “free of applied additional pressure”. However, it is to be understood that in each case free of applied additional pressure is also included.

Obviously, the drive device can also comprise two or more drive components. Here, at least one of the drive components is incorporated in the cooling circuit for cooling the drive component.

The drive device can generally be configured as desired.

Preferably, the drive device is an at least partially electric drive device. For this purpose, the drive device can comprise a rechargeable battery as drive component.

Advantageously, the drive device comprises a fuel cell as drive component. Preferably, the fuel cell is incorporated in the cooling circuit for cooling the fuel cell.

In advantageous embodiments, the discharge system discharges the exhaust air of the fuel cell as gas mass flow. Since the exhaust air of the fuel cell, due to the operation, contains water droplets as liquid, liquid developing during the operation of the fuel cell can thus be employed for the evaporative cooling. This results in an increased efficiency of the motor vehicle and in a more autonomous operation.

Generally, the pressure reducing device can also be configured as desired.

Advantageously, the pressure reducing device is a turbine arranged in the discharge system. The turbine is designed in particular as exhaust air turbine which is driven by the exhaust air of the fuel cell. Preferably, the exhaust air turbine drives a compressor in a cathode gas supply system, with which the fuel cell is supplied with a cathode gas.

The liquid stored in the reservoir can be extracted upstream of the storage volume and fed to the reservoir volume. For this purpose, a liquid extraction device, for example a liquid separator, can be arranged in the discharge system, wherein the liquid path leads from the liquid extraction device to the inlet of the reservoir. It is likewise conceivable that the liquid path leads from the turbine to the inlet of the reservoir. Since liquid is incurred in the turbine during the operation, liquid can thus be easily and efficiently collected in the pressureless reservoir.

Likewise, liquid originating from other parts of the discharge system can be fed to the reservoir volume. For example, liquid from the anode system of the fuel cell can thus also be fed to the reservoir.

Likewise, the reservoir can be employed for extracting liquid from the gas mass flow.

For this purpose, the reservoir is preferably designed as a centrifugal separator for separating liquid from the gas mass flow. For this purpose, the reservoir is designed in particular as a swirl separator or a cyclone separator. The liquid path conducts at least one part of the gas mass flow via the inlet into the reservoir. The supply and the inlet are such that the gas mass flow flows vortically through the reservoir. Thus, the liquid droplets contained in the gas mass flow fall off a wall of the reservoir and flow to the storage volume. In this case, the reservoir advantageously also comprises an outlet for discharging the gas mass flow from the reservoir when no separate water separator is present, which outlet is also referred to as gas outlet in the following. The gas outlet is advantageously arranged above the inlet with respect to the vertical direction.

Preferably, the gas outlet is arranged in the vertical direction at the top, in particular laterally at the top of the reservoir. This results in an improved extraction of liquid from the gas mass flow.

An increased efficiency when extracting liquid from the gas mass flow can also be achieved in that in the reservoir at least one obstacle is arranged in the gas mass flow. Thus, the inertial forces and the wetting of the surfaces are increased by the at least one obstacle. This results in an improved extraction of liquid from the gas mass flow. Thus, the reservoir can be designed as a stake separator.

Advantageously, the inlet of the reservoir is arranged at the top of the reservoir with respect to the vertical direction. Thus, liquid can more easily flow to the storage volume.

Preferably, the supply path leads from an extraction point on the storage volume, moved downwards in the vertical direction, to the evaporative cooling device. Here, the extraction point can correspond to an outlet of the reservoir, which in the following is also referred to as liquid outlet. It is likewise possible that the extraction point is formed in an immersion pipe arranged in the storage volume.

The extraction of liquid from the gas mass flow can also be realised in that the inlet leads into the storage volume. This means that the liquid path conducts at least one part of the gas mass flow via the inlet leading into the storage volume. As a consequence, the gas mass flow flows through liquid already stored in the storage volume. Here, the gas mass flow flows through the already stored liquid in the form of bubbles. During the course of this, the gas mass flow passes liquid droplets contained in the gas mass flow on to the already stored liquid. The reservoir comprises a gas outlet via which the gas mass flow subsequently again flows out of the reservoir. Here, the gas outlet is arranged above the inlet with respect to the vertical direction.

It is conceivable to incorporate the reservoir in the discharge system so that the entire gas mass flow flows through the reservoir. Thus, more liquid can be extracted from the gas mass flow.

When a part of the gas mass flow is supplied to the reservoir, i.e. a part of the gas mass flow is branched off it is preferred when the part of the gas mass flow flowing through the reservoir is subsequently again returned to the discharge system. This means that the gas outlet is fluidically connected to the discharge system downstream of the branch-off point.

It is preferred when the storage volume, particularly preferably the entire reservoir, is arranged below the branch-off point with respect to the vertical direction. Thus, liquid extracted and/or incurred upstream of the reservoir can flow more easily to the reservoir because of gravity. Further, a possible flow of a part of the gas mass flow to the reservoir is also simplified in this way. In addition to this it is thus prevented that liquid from the reservoir flows to the branch-off point and thus to the discharge system or the risk of such a flow is at least reduced and damage to the discharge system is thus prevented or at least reduced.

Embodiments in which the reservoir comprises an overflow pipe are considered preferred. The overflow pipe serves the purpose of preventing a filling level of the reservoir above a limit. Accordingly, the overflow pipe is fluidically connected to the limit of the storage volume which in the vertical direction is arranged at the top. In particular, the overflow pipe leads into the storage volume at the limit. Further, the overflow pipe leads out of the storage volume, preferably out of the reservoir, so that liquid, when the limit is exceeded, can flow out of the reservoir via the overflow pipe. Thus it is prevented in particular that liquid flows out of the reservoir to the discharge system. It is likewise possible with the overflow pipe to prevent or at least reduce damage to the reservoir, which can arise upon a freezing of the liquid stored in the reservoir.

Advantageously, the overflow pipe leads out of the reservoir and downstream of the reservoir and/or the branch-off point to the discharge system. Thus, liquid flowing out of the reservoir reaches the discharge system via the overflow pipe.

Advantageously, the limit is arranged below the inlet with respect to the vertical direction. Thus it is prevented in particular that liquid stored in the reservoir blocks the inlet and/or flows to the discharge system via the inlet.

In preferred embodiments, the overflow pipe is fluidically connected to a venturi nozzle which suctions liquid out of the reservoir via the overflow pipe.

It is preferred when the venturi nozzle is driven by the gas mass flow. This results in a simple and effective discharge of liquid present above the limit out of the storage volume.

Advantageously, the water discharged via the overflow pipe is returned to the gas mass flow. For this purpose, the venturi nozzle can be incorporated in the discharge system and/or be part of the discharge system. Likewise, the venturi nozzle can be integrated in the reservoir.

Preferably, the reservoir comprises, in the vertical direction in a lower portion which delimits the storage volume, a shape tapering downwards with respect to the vertical direction. This means that the reservoir tapers at least in the lower portion, so that the cross-section of the storage volume decreases downwards. In particular it is conceivable that the reservoir as a whole becomes smaller downwards in the vertical direction, i.e. tapers. As a consequence, liquid frozen in the reservoir, if applicable, can more easily expand towards the top. As a result, damage to the reservoir caused by the freezing can be avoided or at least reduced.

In order to avoid damage through freezing or frozen liquid it is alternatively or additionally conceivable to form the reservoir elastically at least in part. Likewise, a free volume, for example by means of the overflow pipe, can be reserved in the reservoir into which the freezing liquid can expand. It is likewise conceivable to monitor the filling level of the reservoir and, when a pre-set filling level is exceeded, drain liquid out of the reservoir, for example via a drain.

It is also conceivable upon an impending freezing of the liquid in the reservoir to drain the liquid and/or pump out the liquid from the reservoir for example by means of the feed device. Here it is conceivable to drain liquid out of the reservoir when specified ambient temperatures are undershot and/or when the motor vehicle is deactivated, i.e. switched off

In preferred embodiments, the liquid path is delimited by a conduit, for example a pipe. Here, the conduit practically leads to the inlet. In particular, the conduit runs between the branch-off point and the inlet. The conduit can also conduct the entire flow in the exhaust system downstream of the pressure-reducing device. Preferably, the conduit runs downwards with respect to the vertical direction to the inlet. Thus, any liquid incurred in the conduit and/or which extracted upstream of the conduit can more easily flow into the reservoir by gravity.

Preferred are embodiments, in which the conduit is configured in such a manner that a condensation in the conduit is promoted. Preferably, the conduit for this purpose comprises at least one structure enlarging the heat-transferring surface. In particular, such a structure is attached within and/or outside the conduit. In particular, the structure is a rib structure. In this way it is possible in particular to enable the condensation of the liquid in the conduit even when the conduit is produced from plastic.

Advantageously, a filter for filtering the liquid is arranged in the supply path, in particular in the reservoir. The filter is in particular configured in such a manner that it retains suspended matter, so that the same does not reach the evaporative cooling device. Thus, damage in this regard is avoided.

It is to be understood that the reservoir can also comprise two or more inlets, wherein an associated liquid path each leads to the respective inlet.

The reservoir can comprise a reservoir pot and a cap closing the reservoir pot. Here, at least one of the connections, i.e. at least one of the inlets and/or outlets, can be formed on the lid.

Practically, the motor vehicle comprises a valve device which optionally, in particular variably, opens and blocks flows along the respective liquid path and/or the supply path.

It is to be understood that other applications in a motor vehicle, for example a cleaning system, can also be supplied with the liquid stored in the reservoir.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It Shows, in Each Case Schematically

FIG. 1 shows a highly simplified representation in the manner of a circuit diagram of a motor vehicle with a reservoir,

FIG. 2 shows a highly simplified representation in the manner of a circuit diagram of a motor vehicle in another exemplary embodiment,

FIG. 3 shows an isometric view of the reservoir,

FIG. 4 shows a section through the reservoir in another exemplary embodiment,

FIG. 5 shows a section through the reservoir in a further exemplary embodiment,

FIG. 6 shows a section through the reservoir in another exemplary embodiment,

FIG. 7 shows a section through the reservoir in a further exemplary embodiment.

### DETAILED DESCRIPTION

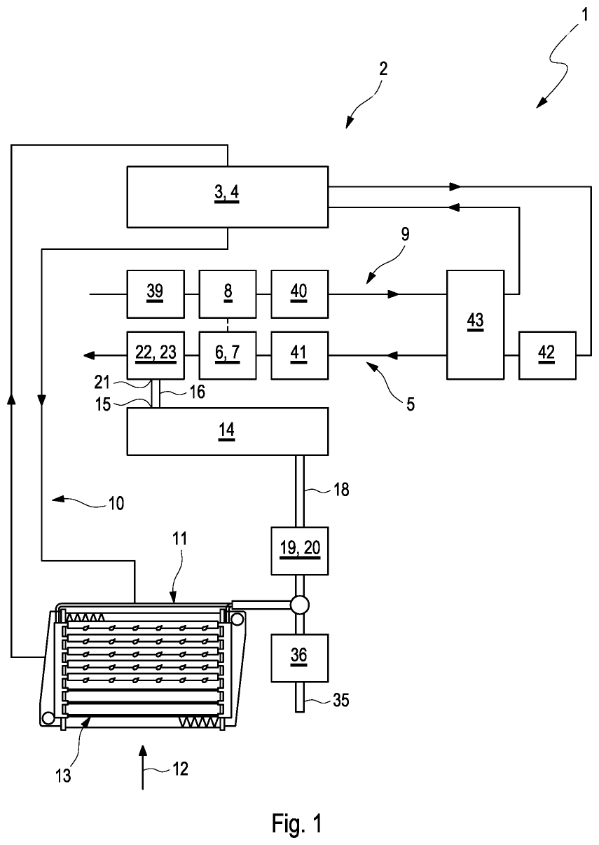

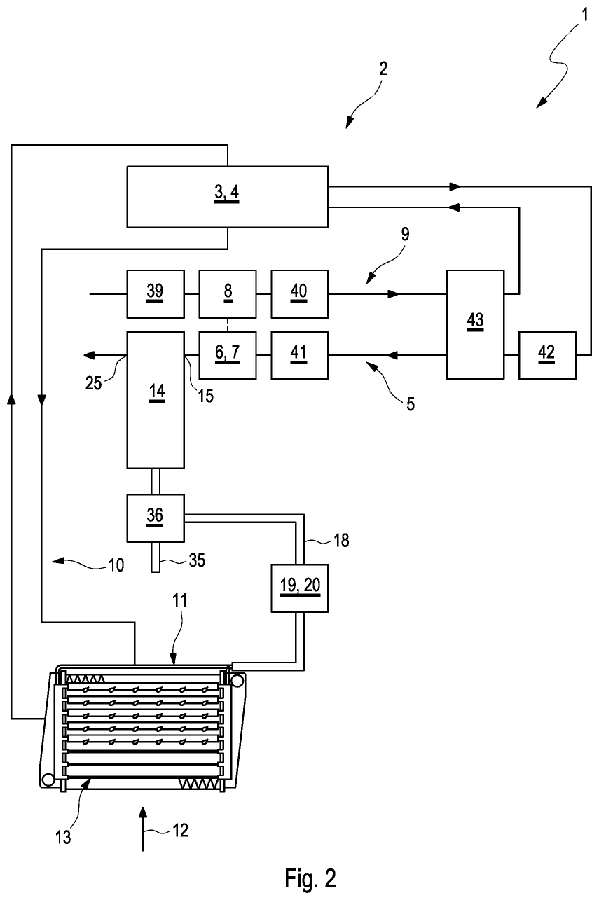

A motor vehicle 1, such as is shown highly simplified and in the manner of a circuit diagram, for example, in the FIGS. 1 and 2, comprises a drive device 2 for driving the motor vehicle 1. The drive device 2 comprises a drive component 3 for driving the motor vehicle 1. In the shown exemplary embodiments, the drive component 3 is a fuel cell 4. Further, the motor vehicle 1 comprises a discharge system 5 through which a gas mass flow flows during the operation, which contains liquid droplets. In the shown exemplary embodiments, the discharge system 5 discharges as gas mass flow the exhaust air developing during the operation of the fuel cell 4, which as liquid droplets contains water droplets. In the discharge system 5, a device 6 is incorporated which is configured in such a manner that the total mass flow downstream of the device 6 is free of applied additional pressure, i.e. in particular is not subjected to any overpressure to speak of. In the following, the device 6 is also referred to as pressure-reducing device 6. In the shown exemplary embodiments, the pressure-reducing device 6 is an exhaust air turbine 7 which is driven by the gas mass flow. In the shown exemplary embodiments, the exhaust air turbine 7 drives a compressor 8. In the shown exemplary embodiments, the compressor 8 is arranged in a cathode gas supply system 9 with which the fuel cell 4 is supplied with a cathode gas. In the process, the compressor 8 compresses the cathode gas to be supplied to the fuel cell 4. Further, the motor vehicle 1 comprises a cooling circuit 10 through which a coolant circulates during the operation. Here, the drive component 3, i.e. in the shown exemplary embodiments the fuel cell 4, is incorporated for cooling in the cooling circuit 10. A coolant radiator 11 indicated in the FIGS. 1 and 2 serves for cooling the coolant in the cooling circuit. For this purpose, the coolant radiator 11 is incorporated in the cooling circuit 10 so that the coolant flows through the coolant radiator 11 during the operation. In addition, a flow path 12 of a gas, in particular of air, in the following also referred to as air path 12, fluidically separated from the coolant, leads through the coolant radiator 11 in order to cool the coolant. A device 13 indicated in the FIGS. 1 and 2 introduces liquid into the air path 12 during the operation, so that the liquid evaporates on the coolant radiator 11. Thus, a more efficient cooling of the coolant in the coolant radiator 11 takes place. The device 13 is also referred to as evaporative cooling device 13 in the following. The liquid supplied to the evaporative cooling device 13 is at least partly extracted from the gas mass flow. In the shown exemplary embodiments, the liquid therefore is water. For storing the liquid 26, in particular water 27 (see FIGS. 4 to 7), the motor vehicle 1 comprises a reservoir 14. The reservoir 14 is free of applied additional pressure, in particular pressureless. This means in particular that no overpressure is substantially present in the reservoir 14. Accordingly, the liquid supplied to the reservoir 14 is extracted at the pressure-reducing device 6 or downstream of the pressure-reducing device 6 out of the gas mass flow flowing through the discharge system 5. For this purpose, a flow path 16 leads from the pressure-reducing device 6 or downstream of the pressure-reducing device 6 to an inlet 15 of the reservoir 14, so that liquid contained in the total mass flow flows into a volume 17 delimited in the reservoir 14, in the following also referred to as storage volume 17 (see FIGS. 4 to 7). In the following, the flow path 16 is also referred to as liquid path 16. For supplying the evaporative cooling device 13 with liquid 26 stored in the reservoir 14, a flow path 16, which in the following is also referred to as supply path 18, leads from the storage volume 17 to the evaporative cooling device 13. Here, the liquid 26 is fed to the evaporative cooling device 13 by means of a feed device 19, for example a pump 20. The feed device 19 is arranged in the supply path 18.

Here, “free of applied additional pressure” is to mean that no specific pressure in addition to the prevailing pressure is generated. The prevailing pressure includes in particular pressure caused through own weight and/or pressure caused by pure flow. For the sake of simplicity, the terms “pressure-free”, “free of overpressure”, “no overpressure” and “overpressure-free” are also used in the following for free applied additional pressure. Here it is clear that free of applied additional pressure is also included in each case.

As is evident from FIG. 1, the liquid path 16 can branch off a branch-off point 21 of the discharge system 5 and lead to the inlet 15. In the exemplary embodiment shown in FIG. 1, the branch-off point 21 is arranged on a liquid extraction device 22 for extracting liquid out of the gas mass flow. Accordingly, liquid extracted out of the gas mass flow flows in the liquid extraction device 22 via the liquid path 16 into the storage volume 17 of the reservoir 14. The liquid extraction device 22 is formed for example as a low-pressure separator 23.

In the exemplary embodiment shown in FIG. 2, the reservoir 14 is incorporated in the discharge system 5. Accordingly, the entire gas mass flow flows through the reservoir 14. In this exemplary embodiment, the entire gas mass flow thus flows downstream of the pressure-reducing device 6.

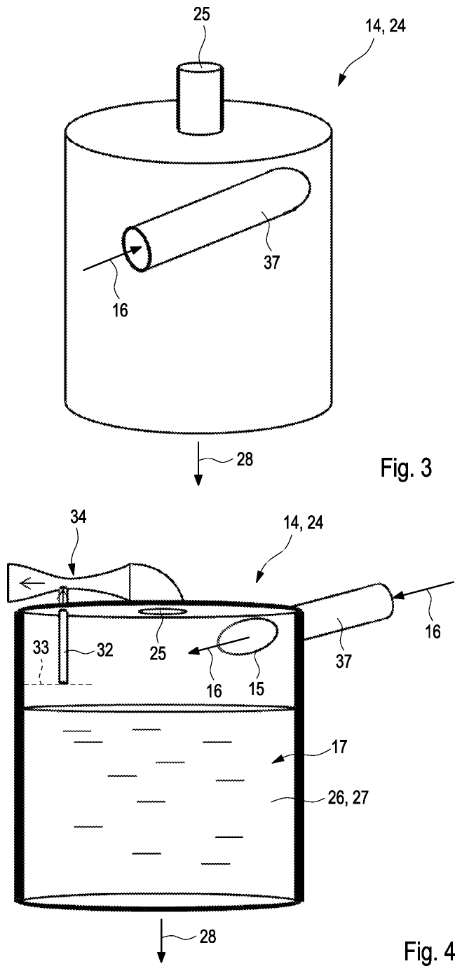

The FIGS. 3 to 7 show different exemplary embodiments of the reservoir 14.

As is evident, further, from the FIGS. 3 to 7, the inlet 15, in the shown exemplary embodiments, is arranged, with respect to the vertical direction 28, on the reservoir 14 at the top.

In the exemplary embodiment shown in the FIGS. 3, 4 as well as 6 and 7, the reservoir 14 is formed as a centrifugal separator 24 for separating liquid out of the gas mass flow. Alternatively or additionally, the reservoir 14 can be formed as a stake separator (not shown). This reservoir 14 can be employed for example in the motor vehicle 1 of the exemplary embodiment shown in FIG. 2. There, the liquid path 16 conducts the entire gas mass flow via the inlet 15 into the reservoir 14. The inlet 15 and the supply of the gas mass flow into the reservoir 14 are such that the gas mass flow flows vortically through the reservoir (not shown). In addition, the reservoir 14 comprises an outlet 25 for discharging the gas mass flow out of the reservoir 14, which in the following is also referred to as gas outlet 25. As a consequence, liquid is incurred within the reservoir 14. In particular, the reservoir is wetted with the liquid on the inside. As is evident, further, from the FIGS. 3 and 4, the gas outlet 25 is arranged with respect to the vertical direction 28 above the inlet 15.

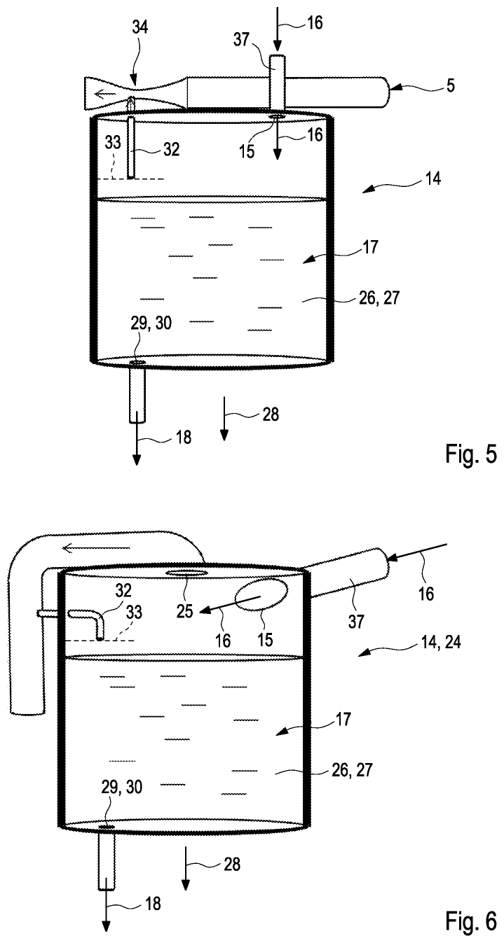

The exemplary embodiment of the reservoir 14 shown in FIG. 5 is employed for example in the motor vehicle 1 according to the exemplary embodiment shown in FIG. 1. There, liquid already extracted previously from the gas mass flow flows via the inlet 15 into the storage volume 17. Accordingly, the reservoir 14 shown in FIG. 5 does not have a gas outlet 25. There, the reservoir 14 with the storage volume 17 is arranged with respect to the vertical direction 28 below the branch-off point 21, so that the liquid flows into the storage volume 17 by gravity.

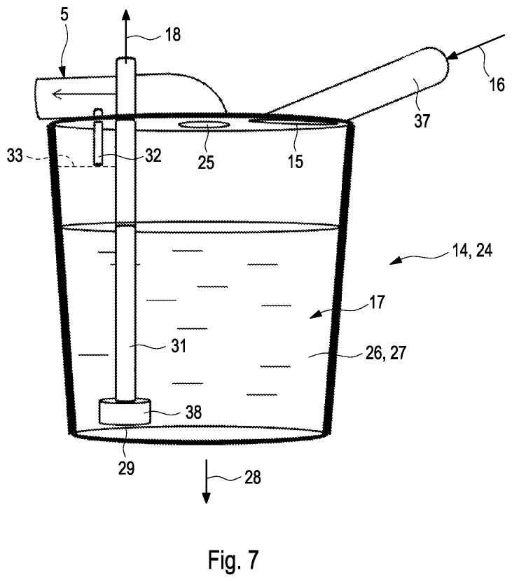

As is merely shown in the FIGS. 5 to 7, the supply path 18 leads from an extraction point 29 on the storage volume 17 to the evaporative cooling device 13. The extraction point 29 is arranged with respect to the vertical direction 28 offset downwards relative to the inlet 15. In the exemplary embodiments of the FIGS. 5 and 6, the extraction point 29 is an outlet 30 of the reservoir 14 which in the following is also referred to as liquid outlet 30. As is evident from FIG. 7, the extraction point 29 can also be arranged on an emersion pipe 31 arranged in the storage volume 17.

As is evident from the FIGS. 4 to 7, the reservoir 14 can comprise and overflow pipe 32. The overflow pipe 32 is fluidically connected to a, with respect to the vertical direction 28, upper limit 33 of the storage volume 17 and leads out of the reservoir 14. Thus, the overflow pipe 32 leads into the storage volume 17 at the upper limit 33. As a consequence, when exceeding the upper limit 33, liquid 26 flows out of the reservoir via the overflow pipe 32. In the shown exemplary embodiments and in the vertical direction 28, the upper limit 33 is arranged below the inlet 15. In the shown exemplary embodiments, the overflow pipe 32 is connected to the discharge system 5 so that liquid 26 flowing out of the reservoir 14 via the overflow pipe 32 is returned to the discharge system 5 downstream of the pressure-reducing device 6 and downstream of the reservoir 14.

As is evident from FIG. 6, the overflow pipe 32 in this exemplary embodiment is altogether arranged in the vertical direction 28 below the inlet 15.

In the exemplary embodiments shown in the FIGS. 4 and 5, the overflow pipe 32 is fluidically connected to a venturi nozzle 34. The venturi nozzle 34 is driven by the gas mass flow so that the venturi nozzle 34 suctions liquid 26 via the overflow pipe 32. Thus, the liquid 26 reaches the discharge system 5 downstream of the reservoir 14. Further, an effective discharge of liquid 26 from the reservoir 14 takes place when the same rises above the upper limit 33.

In particular, the overflow pipe 32 prevents that liquid 26 collected in the reservoir 14 flows to the discharge system 5 via the inlet 15. In addition, a residual volume remains free in the reservoir 14. As a consequence, liquid 26 freezing in the reservoir 14, if applicable, can expand into the free volume. Thus, corresponding damage is prevented.

As is evident from the FIGS. 1 and 2 it is possible to drain liquid 26 out of the reservoir 14 via a drain 35 if required. A drain valve 36 optionally opens or blocks the flow of liquid 26 out of the reservoir 14 via the drain 35. In the exemplary embodiment shown in FIG. 1, the drain branches off the supply path 18 downstream of the feed device 19. In the exemplary embodiment shown in FIG. 2, the drain 35 is connected to the reservoir 14 separately to the supply path 18. Likewise it would be possible to feed liquid 26 stored in the reservoir 14 out of the feed 14 via the feed device 29, in particular to drain the same completely by way of the evaporative cooling device 13.

As is evident from FIG. 7, the reservoir 14 can, with respect to the vertical direction 28, taper downwards at least in a lower portion. As a consequence, the cross-section of the storage volume 17 tapers downwards in the vertical direction 28. This allows a simplified and in particular non-destructive expansion of stored and freezing liquid 26 in the storage volume 17.

As is evident from the FIGS. 3 to 7, the liquid path 16 is delimited by a conduit 37. As is further evident from these figures, the conduit 37 in the shown exemplary embodiments slopes down with respect to the vertical direction 28 towards the inlet 15. Thus, liquid conducted or incurred in the conduit 37 can flow into the storage volume 17 by gravity. Further, a backflow of liquid 26 from the inlet 15 caused by gravity can be avoided or at least reduced.

As is evident in FIG. 7, a filter 38 for filtering the liquid 26 can be arranged in the supply path 18. In the exemplary embodiment shown in FIG. 7, the filter 38 is arranged in the storage volume 17 and on the emersion pipe 31. The filter is configured in such a manner that it filters in particular suspended matter out of the liquid 26.

In the exemplary embodiments of the motor vehicle 1 shown in the FIGS. 1 and 2, a filter 39 for filtering the cathode gas, in the following also referred to as air filter 39, is arranged in the cathode gas supply system 9 upstream of the compressor 8. Downstream of the air filter 39 and downstream of the compressor 8, further, a cooler 40 for cooling the cathode gas is arranged in the cathode gas supply system 9, which in the following is also referred to as air cooler 40. In the shown exemplary embodiments, a fine separator 41 for separating liquid from the gas mass flow is arranged in the discharge system 5 upstream of the pressure-reducing device 6. In addition, a pre-separator 42 for separating liquid out of the gas mass flow is arranged in the discharge system 5 upstream of the fine separator 41. Further, the motor vehicle 1 comprises a humidifying device 43, which is incorporated in the discharge system 5 between the fine separator 41 and the pre-separator 42 and in the cathode gas supply system 9 downstream of the air cooler 40. With the humidifying device 43, the cathode gas is humidified with liquid from the gas mass flow downstream of the air cooler 40.

With the motor vehicle 1 according to the invention, in particular with the reservoir 14, an increased efficiency in the cooling of the drive component takes place, wherein the motor vehicle 1 can additionally be operated more autonomously.

1. A motor vehicle, comprising:
a drive mechanism including a drive component configured to drive the motor vehicles;
a discharge system through which a gas mass flow containing liquid droplets flows during operation;
a pressure-reducing mechanism incorporated in the discharge system, the pressure-reducing mechanism configured such that the gas mass flow downstream of the pressure-reducing mechanism is free of applied additional pressure;
a cooling circuit through which a coolant circulates during operation, the drive component incorporated in the cooling circuit for cooling the drive component;
a coolant radiator, through which the coolant flows during operation and through which, fluidically separated from the coolant, an air path extends for cooling the coolant;
having an evaporative cooling mechanism configured to introduce liquid into the air path, so during operation such that the liquid evaporates at least one of on and upstream of the coolant radiator;
a reservoir free of applied additional pressure;
a liquid path extending from one of the pressure-reducing mechanism and downstream of the pressure-reducing mechanism to an inlet of the reservoir such that the liquid contained in the gas mass flow flows into a storage volume of the reservoir; and
a supply path which extending from the storage volume to the evaporative cooling mechanism.

2. The motor vehicle according to claim 1, wherein:
the drive component is a fuel cell;
the discharge system discharges exhaust air of the fuel cell as the gas mass flow; and
the fuel cell is incorporated in the cooling circuit.

3. The motor vehicle according to claim 1, wherein the pressure-reducing mechanism is a turbine.

4. The motor vehicle according to claim 1, wherein:
the reservoir is configured as at least one of a stake separator and a centrifugal separator for separating liquid from the gas mass flow;
the liquid path conducts at least one part of the gas mass flow into the reservoir via the inlet;
the inlet is arranged such that the gas mass flow flows vertically through the reservoir; and
the reservoir includes a gas outlet, which, with respect to a vertical direction, is arranged above the inlet such that the gas mass flow flows out of the reservoir via the gas outlet.

5. The motor vehicle according to claim 1, wherein:
the inlet, with respect to a vertical direction, is arranged on the reservoir at a top of the reservoir; and
the supply path extends from an extraction point on the storage volume, which with respect to the vertical direction is disposed below the inlet, to the evaporative cooling device mechanism.

6. The motor vehicle according to claim 1, wherein the reservoir is incorporated in the discharge system downstream of the pressure-reducing mechanism such that an entirety of the gas mass flow flows through the reservoir.

7. The motor vehicle according to claim 1, wherein the liquid path extends from a branch-off point of the discharge system to the inlet.

8. The motor vehicle according to claim 1, wherein the reservoir includes an overflow pipe, fluidically connected to an, with respect to a vertical direction, upper limit of the storage volume and extending out of the reservoir, so such that liquid, when the upper limit is exceeded, liquid flows out of the reservoir via the overflow pipe.

9. The motor vehicle according to claim 8, wherein the overflow pipe is fluidically connected to a venturi nozzle, which is driven by the gas mass flow and which, during operation, suctions liquid via the overflow pipe.

10. The motor vehicle according to claim 8, wherein the upper limit, with respect to the vertical direction, is arranged below the inlet.

11. The motor vehicle according to claim 7, wherein the storage volume is arranged, with respect to a vertical direction, below the branch-off point.

12. The motor vehicle according to claim 1, wherein:
the reservoir includes at least one, with respect to a vertical direction, lower portion which delimits the storage volume; and
the lower portion of the reservoir tapers downwards with respect to the vertical direction such that a cross-section of the storage volume decreases downwards.

13. The motor vehicle according to claim 1, further comprising a conduit, wherein:
the conduit delimits the liquid path; and
the conduit, with respect to a vertical direction, slopes down towards the inlet.

14. The motor vehicle according to claim 1, further comprising a filter for filtering the liquid arranged in the supply path.

15. The motor vehicle according to claim 1, wherein the storage volume of the reservoir amounts to 2 to 20 litres.

16. The motor vehicle according to claim 1, further comprising a pump disposed in the supply path.

17. The motor vehicle according to claim 1, further comprising:
a cathode gas supply system via which the drive component is supplied cathode gas;
a compressor arranged in the cathode gas supply system and configured to compress cathode gas that is supplied to the drive component during operation; and
wherein the pressure-reducing mechanism is configured to drive the compressor.

18. The motor vehicle according to claim 1, further comprising:
a liquid separator configured to extract liquid from the gas mass flow;
a branch-off point arranged on the liquid separator; and
wherein the liquid path extends from the branch-off point to the inlet such that liquid extracted via the liquid separator is flowable into the reservoir.

19. The motor vehicle according to claim 14, wherein the filter is arranged in the reservoir.

20. A motor vehicle, comprising:
a drive mechanism including a drive component configured to drive the motor vehicle;
a discharge system through which a gas mass flow containing liquid droplets flows during operation;
a pressure-reducer incorporated in the discharge system, the pressure-reducer configured such that the gas mass flow downstream of the pressure-reducer is free of applied additional pressure;
a cooling circuit through which a coolant circulates during operation, the drive component incorporated in the cooling circuit for cooling the drive component;
a coolant radiator through which the coolant flows during operation and through which, fluidically separated from the coolant, an air path extends for cooling the coolant;
an evaporative cooler configured to introduce liquid into the air path during operation such that the liquid evaporates at least one of on and upstream of the coolant radiator;
a reservoir free of applied additional pressure, the reservoir including a storage volume and an inlet;
a liquid path extending from one of the pressure-reducer and downstream of the pressure-reducer to the inlet of the reservoir such that the liquid contained in the gas mass flow flows into the storage volume of the reservoir;
a supply path extending from the storage volume to the evaporative cooler;
a fine separator arranged in the discharge system upstream of the pressure-reducer, the fine separator configured to separate liquid from the gas mass flow;
a pre-separator arranged in the discharge system upstream of the fine separator, the pre-separator configured to separate liquid from the gas mass flow;
a cathode gas supply system via which the drive component is supplied cathode gas;
an air cooler arranged in the cathode gas supply system, the air cooler configured to cool the cathode gas; and
a humidifier incorporated in (i) the discharge system between the fine separator and the pre-separator and (ii) the cathode gas supply system downstream of the air cooler, the humidifier configured to humidify the cathode gas with liquid separated from the gas mass flow.
